(19) United States
(12) Patent Application Publication
(10) Pub. No.: US 2006/0095854 A1
(43) Pub. Date: May 4, 2006

(54) Method and apparatus for content download

(76) Inventors: James M. Funk, Menlo Park, CA (US); Steve Shannon, Hillsborough, CA (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/968,224

(22) Filed: Oct. 18, 2004

(51) Int. Cl. G06F 17/00

(52) U.S. Cl. 715/749

(57) ABSTRACT

A method and apparatus is provided to send information to a video-on-demand (VOD) server. A VOD client device retrieves this information and performs download of multimedia content using this information for subsequent viewing. In one embodiment, this information is provided to the VOD server by a content server upon a user's request made from a computer system other than the VOD client device. In another embodiment, this information is provided to the VOD server by a user's computer system other than the VOD client device; such information having been obtained by the user's computer system from the content server.

### BACKGROUND OF THE INVENTION

1. Field of the Invention

The invention relates generally to the fields of video on demand (VOD) and web browsing. In particular, the invention relates to a user's ability to request, while browsing the Internet, a download of content from a website via a managed VOD service to a VOD client device for storage and viewing.

2. Description of Related Technology

Download and View Video-on-Demand

With the recent advances in computing, signal processing and telecommunications technologies, the ability to download and watch audio/video content over a network connection is opening up new opportunities to deploy VOD services.

VOD generally refers to a personalized viewing service offered by a content provider or a network operator over a network to a content viewer. The viewer is able to start a VOD session by electronically browsing through a catalog of available content, selecting a program for viewing and receiving the selected content for viewing via a content device over the network.

Content Discovery in a Download-and-View VOD System

Several techniques are used in the conventional art for discovering content. An electronic program guide (EPG) offers user information regarding what is available for viewing. In the recent years, due to ubiquity of the Internet and its availability for not just transmitting EPGs but also the content, the Internet is becoming a commonly used medium for content discovery. For example, using a web browser, a user can browse a web site and download content and view it on a personal computer or similar platform.

If a user desires to download and view content on a television monitor, however, for example in case of an entertainment or informational video, such a content discovery and delivery method has limitations. For example, if a PC is used for browsing the Web and selecting content, there is no convenient way of transferring and viewing the convenient on a television monitor. In the case when web browsing is performed using a television as the display, the user is either limited to browsing web pages re-purposed for television display or viewing regular web pages with the visual limitations of the television display; each option limiting the user's experience.

A method that allows the combination of browsing for content using a PC and viewing of the content using an apparatus connected to a television is therefore desirable. Such a method should preferably also enforce a content provider's content ownership rights and provide for implementation of appropriate business systems interfaces such as transaction logging, user authentication and so on, between the content owner and the provider of such a service.

### SUMMARY OF THE INVENTION

The present invention addresses the foregoing needs by providing, in various embodiments, a method and apparatus for requesting a download of content to a client device, while browsing content available on a content provider's server, possibly using a device other than the client device to perform the browsing.

In a first aspect of the invention, a method to transfer, in response to a user command initiated from a first computer system, an instruction from a second computer system to a third computer system is disclosed. The instruction additionally includes information required by a fourth computer system to download multimedia content. The method further includes synchronizing the third computer system with the fourth computer system so as to transfer the information required by the fourth computer system to download the multimedia content. In one exemplary embodiment, the user command is initiated while browsing a web page. The instruction could further include metadata regarding the multimedia content and an indication of where the multimedia content can be accessed for download by the fourth computer system

In a second aspect of the invention, a method, that includes the steps of receiving, at a first computer system from a second computer system, an instruction to schedule a download of multimedia content by a third computer system, and synchronizing the first computer system with the third computer system so as to transfer information required by the third computer system to download the multimedia content is disclosed. In one embodiment, the first computer system hosts a program guide that includes metadata describing VOD content available for download via the Internet to the third computer system from multiple disparate content sources.

### BRIEF DESCRIPTION OF THE DRAWINGS

The above and other features and advantages of the present invention are hereinafter described in the following detailed description of illustrative embodiments to be read in conjunction with the accompanying drawings, wherein like reference numerals are used to identify the same or similar system parts and/or method steps, and in which:

FIG. 1 is a functional block diagram illustrating an exemplary IP network configuration useful with the present invention.

FIG. 2 illustrates a flowchart of high-level algorithmic steps performed in an embodiment of the present invention.

FIG. 3 illustrates a flow graph of signals exchanged among a user computer, a content provider's server, a VOD service provider's server and a VOD client device, to facilitate downloading and viewing of content according to an embodiment of the present invention wherein the content provider's server requests the VOD service provider's server to add a content download request to the user's work list.

FIG. 4 shows an illustrative embodiment of the steps taken at a content provider's server to receive a user's download request, verify its validity and process it to notify the user's VOD service provider of the request.

FIG. 5 shows an illustrative embodiment of the steps taken at a VOD service provider's server to receive a user download request forwarded by a content provider's server, verify validity of the request and process it for notification to the user's VOD client device.

FIG. 6 shows an exemplary sequence diagram of various signals exchanged among the following four architectural blocks as per an embodiment of the present invention: a content server, a user's computer system, a VOD service provider's server and a VOD client device. In this embodiment, the user's computer system requests the VOD service provider's server to add a content download request to the user's work list.

FIG. 7 shows an illustrative embodiment of the steps taken at a content provider's server to receive a user's download request and send back information regarding the content needed by the user to perform subsequent download-and-view operation.

FIG. 8 shows an illustrative embodiment of the steps taken at a user's computer system to send a first request for content viewing to a content server and a second, request to a VOD service provider's server to for subsequent download by the user's VOD client device.

FIG. 9 shows an illustrative embodiment of the steps taken at a VOD service provider's server to receive a user download request from a computer system other than the user's VOD client device, verify validity of the request and process it for notification to the user's VOD client device.

### DETAILED DESCRIPTION

Reference is now made to the drawings wherein like numerals refer to like parts throughout. Described herein is a method and apparatus for downloading content for viewing to a set-top appliance while browsing the Web using another computer.

As used herein, the term “VOD” is meant to include on-demand delivery of audio, video, graphical icons, software, computer games, etc.

As used herein, the term “VOD server” is meant to include network-side server resources of a VOD system in the form of a computing platform, including content servers, billing system servers, web interface servers, the network operator's management servers, and so on.

As used herein, the term “VOD service provider” is meant to refer to an entity, other than a home or end-user, involved in manufacturing, design, deployment or maintenance of a system embodying the present invention, including but not limited to cable system operators, satellite providers, DSL internet providers, content providers, client device manufacturers, etc. as appropriate.

As used herein, the term “content” refers to audio, video, graphics files (in uncompressed or compressed format), icons, software, text files and scripts, data, binary files and other computer-usable data used to operate a client device and produce desired audio-visual effects on a client device for the viewer.

As used herein, the term “content server” refers to a server that hosts and makes available content for download or a server that hosts a web page (or pages) that provide information regarding availability of content at another server. The content itself may be distributed on multiple servers, possibly distinct from the server that hosts the web session that makes a user aware of the content. All such servers are collectively called “content servers.”

As used herein, the terms “computer-implemented method,” “computer program”, “routine,” and “subroutine” are substantially synonymous, with “computer method” being used typically (but not exclusively) to describe collections or groups of the latter two elements. Such programs and routines/subroutines may be rendered in any language including, without limitation, C#, C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ and the like. In general, however, all of the aforementioned terms as used herein are meant to encompass any series of logical steps performed in a sequence to accomplish a given purpose.

In view of the above, it should be appreciated that some portions of the detailed description that follows are presented in terms of algorithms and symbolic representations of operations on data within a computer memory. These algorithmic descriptions and representations are the means used by those skilled in the computer science arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like. It should be borne in mind, however, that all of these and similar terms are to be associated with the appropriate physical quantities and are merely convenient labels applied to these quantities. Unless specifically stated otherwise, it will be appreciated that throughout the description of the present invention, use of terms such as “processing”, “computing”, “calculating”, “determining”, “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices. Where illustrated, the user interfaces presented herein should be regarding as examples thereof and not read so as to limit the scope of the present invention. Layouts, images and other elements of such user interfaces are not critical to the present invention. The functionality provided by such interfaces is reflected in the claims following this description and it is that functionality which forms a component of the present invention.

The present invention can be implemented with an apparatus to perform the operations described herein. This apparatus may be specially constructed for the required purposes, or it may comprise a general-purpose computer, selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and processes presented herein are not inherently related to any particular computer or other apparatus. Various general-purpose systems may be used with programs in accordance with the teachings herein, or it may prove convenient to construct more specialized apparatus to perform the required method. For example, any of the methods according to the present invention can be implemented in hard-wired circuitry, by programming a general-purpose processor or by any combination of hardware and software. One of ordinary skill in the art will immediately appreciate that the invention can be practiced with computer system configurations other than those described below, including hand-held devices, multiprocessor systems, microprocessor-based or programmable consumer electronics, DSP devices, network PCs, minicomputers, mainframe computers, and the like. The invention can also be practiced in distributed computing environments where tasks are performed by remote processing devices that are linked through a communications network. The required structure for a variety of these systems will appear from the description below.

The methods of the present invention may be implemented using computer software. If written in a programming language conforming to a recognized standard, sequences of instructions designed to implement the methods can be compiled for execution on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, application, etc.), as taking an action or causing a result. Such expressions are merely a shorthand way of saying that execution of the software by a computer causes the processor of the computer to perform an action or produce a result.

Overview

The methods and apparatus described herein make use of the ubiquity of IP networks and technological advances that allow for the use of the IP not just to view and interact with web pages but also download multimedia files.

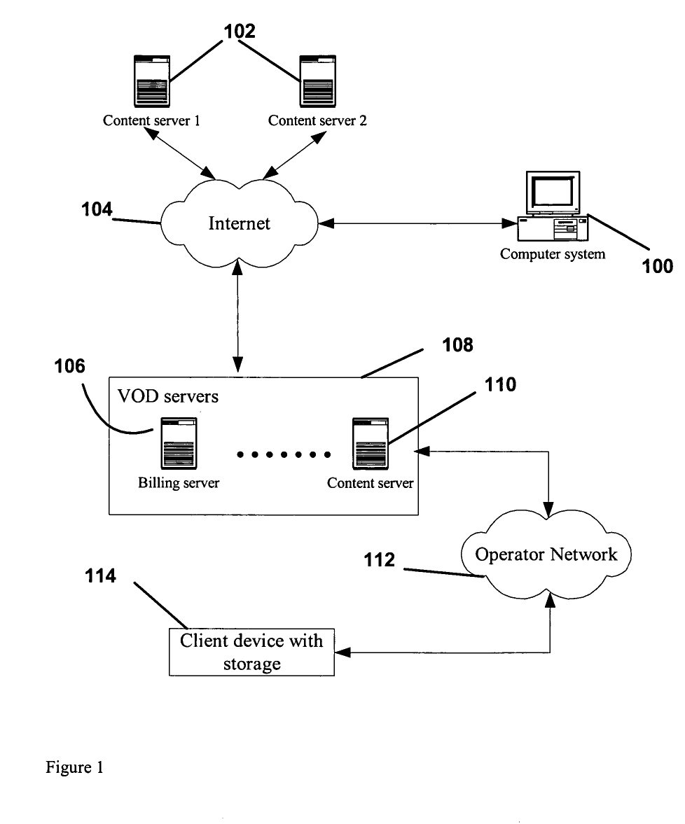

FIG. 1 shows a block diagram of an exemplary computer network in which the present invention can be implemented. The figure shows a computer system 100, content servers 102 and a group of VOD servers (shown as box 108), all communicatively coupled to each other via a network 104. The group of VOD servers consists of server(s) that perform functions such as billing and account management (106) and hosting of VOD content and a program guide (110). These VOD servers are communicatively coupled with a VOD client device 114, via an Internet service provider's operator network 112. This network diagram represents typical Internet connectivity available to residential users, but is not intended to limit the present invention. In practical situations, some variations to this network configuration are possible. For example, in the case when a user browses the Internet using a home computer, the computer system 100 will also be connected to the network 104 through the operator network. In many cases, the operator network that operates between residential users and the Internet, allows limited bandwidth traffic from the user premises to the Internet. The traffic is also restricted by a firewall (or similar means) operated by the network operator to restrict the communication to only certain type of services. A ubiquitous symmetric IP connection between home users and the Internet cannot therefore be taken for granted.

Content Download

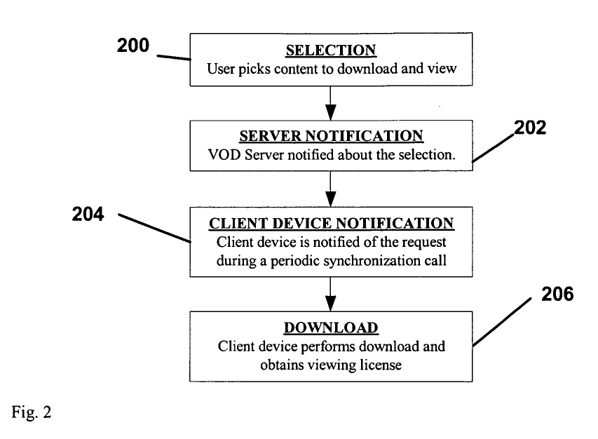

FIG. 2 illustrates (in overview fashion) the basic steps performed in the process of a download-and-view VOD content fulfillment. Initially, at step 200, multimedia content for downloading and viewing is selected. Various embodiments of the selection mechanism to make such a request are possible in which the content is selected for the user either explicitly (e.g., user performing a selection operation) or implicitly (e.g., by an automatic selection and download of content based on user's preferences, subscriptions and memberships).

This user instruction (implicit or explicit) gets forwarded to a VOD server where it is processed and added to a work list for the user's client device (202). Next, the client device becomes aware of the requested download, for example, during a synchronization process with the VOD server (204). Finally, the client device performs the actual download and stores the multimedia content on a local storage device (e.g., a hard drive) for later viewing by the user (206).

Descriptions of Exemplary Embodiments

Various embodiments of the above-described method may be implemented. Two such exemplary embodiments are described below to further illustrate the present invention.

### EXAMPLE 1

### The VOD Server is Contacted by the Content Server

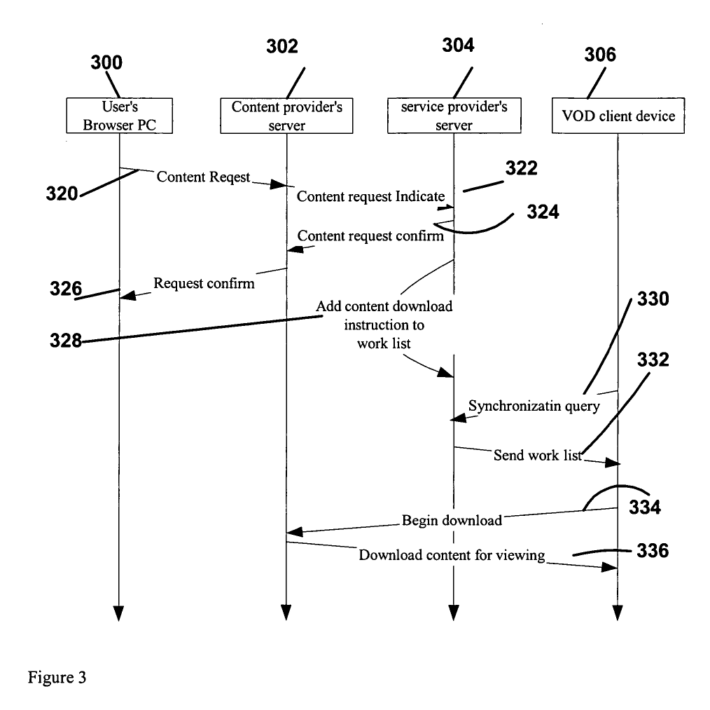

Referring to FIG. 3, four entities are shown exchanging signals with each other: a user's computer system such as a PC (300), a content provider's server (302), a VOD service provider's server (304) and the user's VOD client device 306. In this embodiment, the user initiates a content download request 320 (implicit or explicit) that is conveyed to the content provider's server. After processing this request, the content provider's server forwards it to the service provider's server (322). Once the content provider's server receives and processes the request, a confirmation is sent back to the content provider's server (324), which is then processed and forwarded to the user's computer system (326).

The VOD server 304 adds the download request to a work list maintained by the server for the user's client device (328). At a later time, the client device calls the VOD server with a synchronization query (330). During the synchronization step, the “to-do” items on the work list are sent to the client device (332). A download manager at the client device receives the this work list, adds the new download request to its local work list and thereafter (e.g., at a time and priority indicated by the work list) begins downloading the multimedia content from the content provider's server (334). This content is then downloaded from the content provider's server to the client device (336) for local storage and subsequent viewing.

Content Server Tasks in Example 1

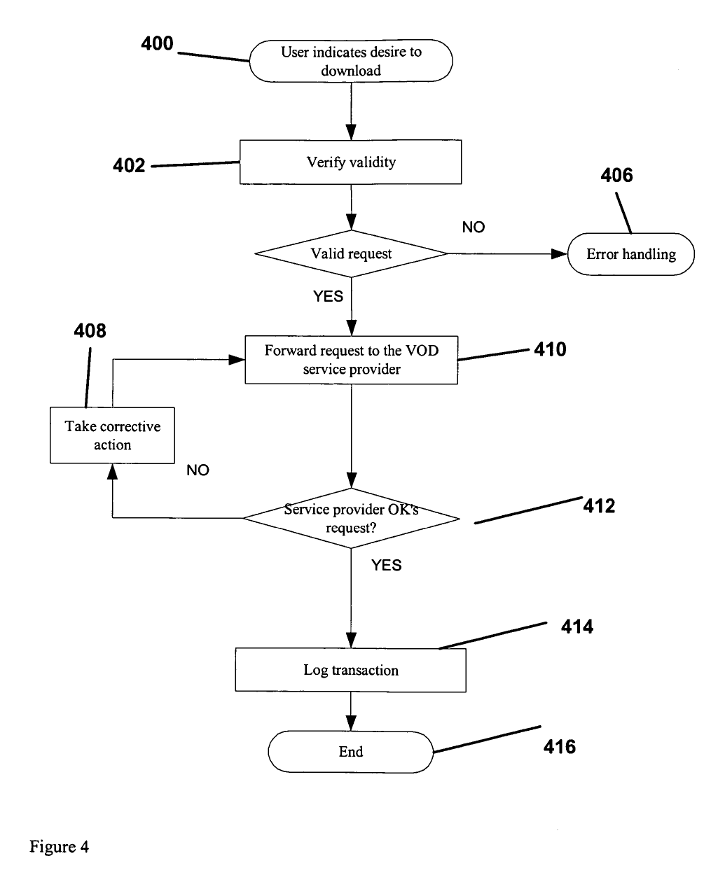

Refer to the flowchart of FIG. 4. While browsing through the programs available on a content server (or a guide indicative thereof), a user requests a download of content for viewing (step 400). The content server processes the request to verify one or more of the contents thereof (e.g., the content server may need to verify that the request is properly formatted, all required information regarding the user's identity has been provided, and sufficient information exists to be able to associate the request with a particular VOD client device). Depending on the implementation, the content server may or may not have the ability to parse and verify the data contained within the request to determine whether or not the request has come from a valid VOD service subscriber.

If the content server detects an error with the request, an appropriate error handling step may be invoked (406). In various embodiments, such error handling could involve sending a message to the user describing the error, or sending a notification to the content provider's server of the source of error (e.g., persistent requests from an unauthorized or unverifiable user).

If the request is deemed valid, the content server forwards the content download request to the service provider (410). Depending on the implementation, the content server may exchange additional messages with the VOD provider's server, including for example providing the multimedia content to the VOD service provider if needed. One such scheme of content provisioning is described in co-pending U.S. patent application Ser. No. ______ (Attorney Docket No. 7177P003) entitled “Method and apparatus for content provisioning in a video on demand system” filed ______, 2004, assigned to the assignee of the present invention and incorporated herein by reference. Such an exchange may be accomplished by establishing a separate communication channel between the servers or by encapsulating or adding a message to the user's multimedia download request. In some cases, the VOD server may return an acknowledgement to the content provider indicating that it has accepted the content download request (412). The content server may optionally log the transaction (414) for future reference (e.g. quality assurance, billing transaction history, etc.), at which point the processing of the user's content download request is completed (416).

If on the other hand, the service provider does not approve the content download request, corrective action may be taken (408) and more attempts may be made to forward the user's content download request. Such corrective action could include simple re-tries (for example, in case of network communication errors), getting more information from the user, providing more details regarding the content provider, and so on.

VOD Service Provider's Server Tasks in Example 1

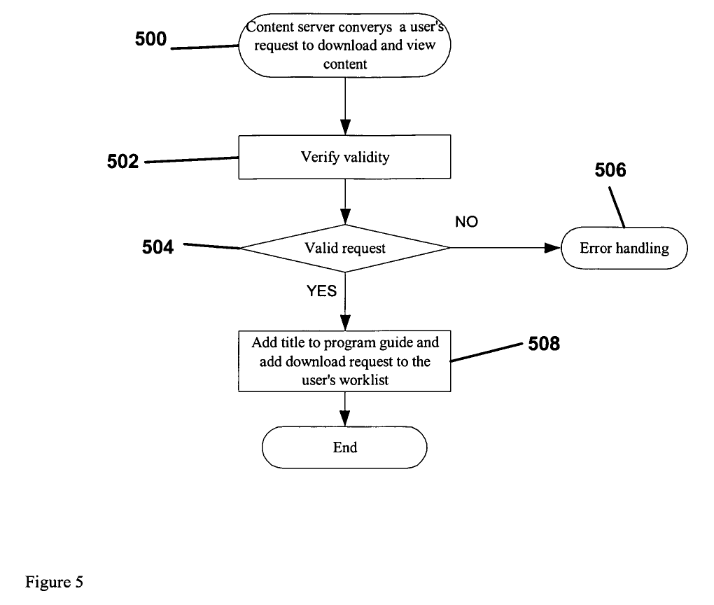

Referring to FIG. 5, when a content server contacts the VOD service provider's server with a user's request to download content (500), the VOD server verifies validity of the request (502). In various embodiments, such validation could comprise of one or more of the following steps: ensuring the content provider is an authorized provider to the VOD service, ensuring that the user is a legitimate VOD service subscriber, determining whether or not the requested content is available on the VOD server or on the content provider's server, determining whether or not the content is included in a VOD program guide, matching the user's viewing profile with the user's content viewing rights, ensuring the content is compatible with a content advisory level set by the user, and so on. If the request is invalid, the appropriate error handling is invoked (506). Depending on the implementation and the reason for this error, the error-handling step could involve iterative or non-iterative message transaction with the content provider, logging of such messages and transaction details and error notification to a human operator. If the request is valid (step 504), the necessary details (e.g., the location of the actual media file) of the requested multimedia title are added to a work list maintained by the VOD server for the requesting user's client device. The matching of a user request received via the content provider's server and the identity of a client device can be performed based on information contained within the request.

### EXAMPLE 2

### The VOD Server is Contacted by the User's Computer System

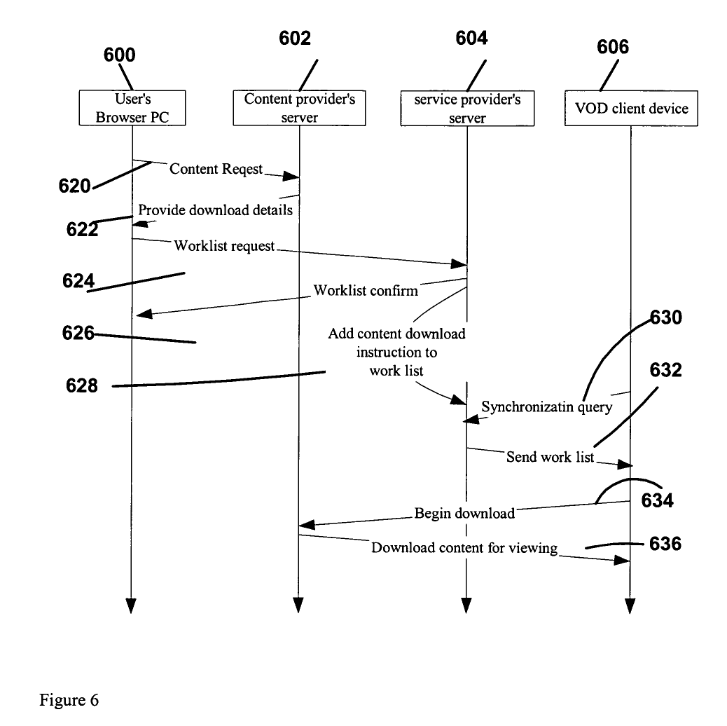

Referring to FIG. 6, four communication platforms are shown exchanging signals with each other: a user's computer system such as a PC (600), a content provider's server (602), a VOD service provider's server (604) and the user's client device 606. In this example, the user initiates a content download request 620 that is conveyed to the content provider's server. After processing this request, the content provider's server sends a message back to the user's computer (622) that includes information for the user's computer system to perform subsequent communication with the VOD server. Once the user's computer system receives this information, it contacts the VOD server with a request to schedule a download of the content to the user's client device (624). The VOD server validates this request and adds it to the work list for the user's client device. At a later time, the client device synchronizes with the VOD server (630) and the “to-do” items on the work list are sent to the client device (632). A download manager at the client device receives the new download request, adds it to a local work list and, at the appropriate time, begins downloading the multimedia content (634). This content is then downloaded from the content provider's server to the client device (636) for local storage and subsequent viewing.

Content Server Tasks for Example 2

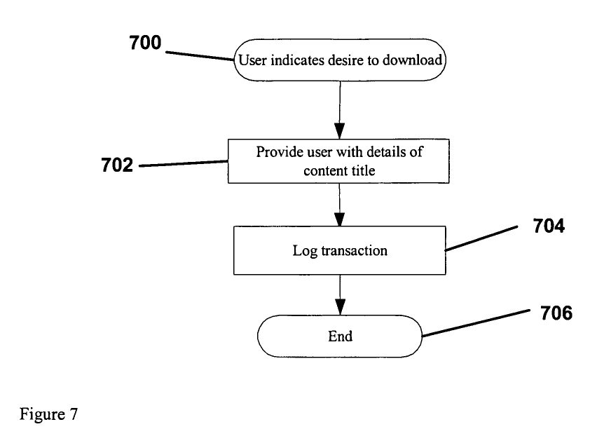

Referring to FIG. 7, when a user requests a download of content for viewing (step 700), the content server performs an optional validation step and provides the user with details needed to download the content (702). In one embodiment of this present invention, all such information may already have been provided to the user. For example, the web page data sent to the user to display the availability of content may also contain metadata needed to complete the download-and-view operation. In another embodiment, such information may only be provided after the user provides the proper credentials (e.g., password authentication, or authentication via a browser plug-in software module's digital identity, and so on). Subsequently, the content server logs the transaction (704) for future use (e.g., billing, quality assurance, transaction history, etc.).

User Computer System's Tasks for Example 2

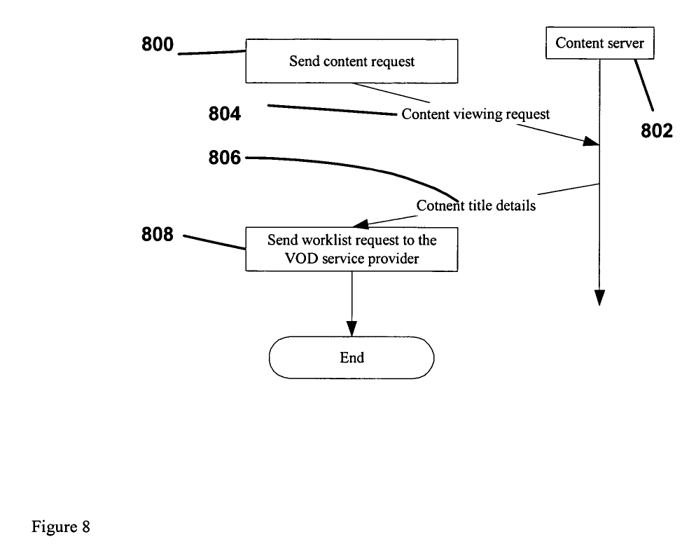

Referring to FIG. 8, when the user computer system sends a content request (800) to a content server 802, such a request (804) may include details about the user's credentials. Such details may be provided by the user's input (e.g., password, credit card number, etc.) or via a digital signature provided by a software module (e.g., a plug-in module for the web browser). When details about the content are received at the user's computer system (806), the computer system then contacts a VOD service provider's server and requests the download of the desired multimedia content (808). The task is terminated upon receiving an indication of successful reception of the request (810).

VOD Service Provider's Server Tasks for Example 2

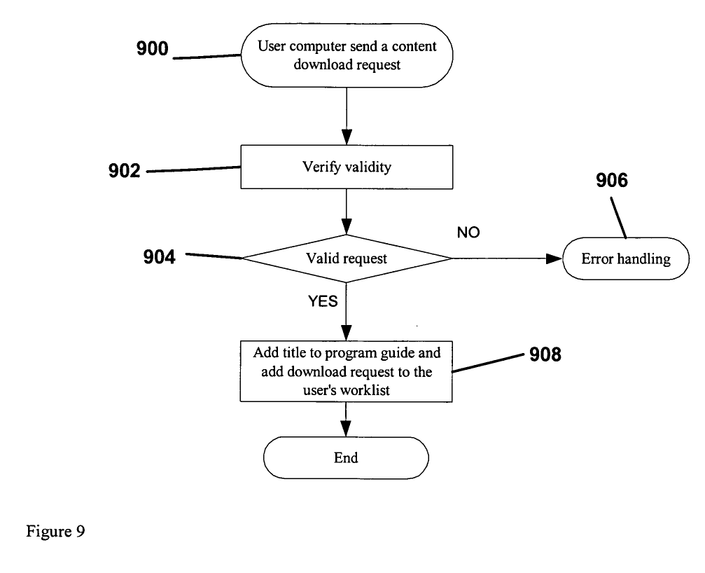

Referring to FIG. 9, when the VOD server receives a request to download multimedia content to a client device (900), it verifies validity of the request. Such verification may including examining one or more of, but not limited to, the requester's identity (e.g., a digital identity certificate associated with the request), the content provider's business relationship with the VOD service provider, whether or not the requested content is present in the service provider's electronic program guide, the user's content advisory settings, and so on. If the request is found to be valid, it is added to the work list maintained by the VOD server for the user's client device (908). If the request is found to be invalid, an error handling routine in invoked (906).

Download-and-View Performed by the Client Device

Various methods to perform download-and-viewing of multimedia content once a download request is placed on the VOD server's copy of the work list for a client device are possible. One such method is described in co-pending U.S. patent application Ser. No. 10/928,451 (Attorney Docket No. 7177P001) entitled “Method and apparatus for downloading content” filed Aug. 27, 2004, assigned to the assignee of the present invention and incorporated herein by reference. In some implementation, the client devices could implement a mechanism that allows filtering of junk or spam content providers from pushing unwanted content to a user's device. Such filtering based on credentials of the requester could be done at a VOD service provider's server or at the client device. For example, in the download method referenced above, when a download item is added to the work list, the requester's identity may also be added. The download manager then can look at who has requested the download and decide to not perform the download, if the requester is unknown.

Content Rights Management

Content rights associated with multimedia content can be enforced at various points in the processes described above. In general, it is advantageous from a user's perspective to obtain a viewing license for downloaded content concurrently with or prior to the content download. One such method of obtaining a viewing license is described in co-pending U.S. patent application Ser. No. ______ (Attorney Docket No. 7177P007) entitled “Aggregated program guide for download and view video on demand service” filed ______, 2004, assigned to the assignee of the present invention and incorporated herein by reference.

In the foregoing specification, the invention has been described with reference to specific exemplary embodiments thereof. It will, however, be evident to those of ordinary skill in the art that various modifications and changes may be made thereto without departing from the broader spirit and scope of the invention as set forth in the appended claims. The specification and drawings are, accordingly, to be regarded in an illustrative rather than a restrictive sense and that it understood that the following claims including all equivalents are intended to define the scope of the invention.

What is claimed is:

1. A method, comprising transferring, in response to a user command initiated from a first computer system, an instruction from a second computer system to a third computer system, the instruction including information required by a fourth computer system to download multimedia content; and synchronizing the third computer system with the fourth computer system so as to transfer the information required by the fourth computer system to download the multimedia content.

2. The method of claim 1, wherein the user command comprises selection of an element of a Web page.

3. The method of claim 2, wherein the instruction includes metadata regarding the multimedia content and an indication of where the multimedia content can be accessed for download by the fourth computer system.

4. The method of claim 2, wherein synchronizing the third computer system with the fourth computer system comprises synchronizing a content management application hosted at the fourth computer system.

5. The method of claim 4, wherein the synchronizing is performed in response to a query by the content management application.

6. A method, comprising receiving, at a first computer system from a second computer system, an instruction to schedule a download of multimedia content by a third computer system, and synchronizing the first computer system with the third computer system so as to transfer information required by the third computer system to download the multimedia content.

7. The method of claim 6, wherein synchronizing the third computer system comprises synchronizing a content management application hosted at the third computer system.

8. The method of claim 7, wherein the synchronizing is performed in response to a query by the content management application to the first computer system.

9. The method of claim 6, wherein the first computer system hosts a video-on-demand (VOD) electronic program guide (EPG) that includes metadata describing VOD content available for download via the Internet to the third computer system from multiple disparate content sources.

10. The method of claim 6, further comprising automatically downloading the multimedia content to the third computer system.
